(19) United States
(12) Patent Application Publication
(10) Pub. No.: US 2013/0258216 A1
(43) Pub. Date: Oct. 3, 2013

(54) PICO PROJECTION LIGHT SYSTEM

(71) Applicants: Shin-Gwo Shiue, Hukou Township (TW); Tze-Yun Sung, Hukou Township (TW)

(72) Inventors: Shin-Gwo Shiue, Hukou Township (TW); Tze-Yun Sung, Hukou Township (TW)

(21) Appl. No.: 13/434,874

(22) Filed: Mar. 30, 2012

(51) Int. Cl. G02F 1/13363

(52) U.S. Cl. 349/9

(57) ABSTRACT

A pico projection light system for improving an optical engine of a pico projector and enhancing effects of lighting. The improved pico projection light system comprises a light-emitting diode acting as a light source, a set of three collimators arranged with spaces therebetween and converting light emitted by the light-emitting diode into a parallel light, a set of two lens arrays arranged with spaces therebetween and uniformizing the parallel light, a set of two positive lenses arranged with spaces therebetween and magnifying light emitted from the lens arrays, a polarizing beam splitter receiving the magnified light and having a horizontal polarized light pass therethrough, and a reflective liquid crystal panel reflecting light and modulating optical signals projecting on a screen.

### BACKGROUND OF THE DISCLOSURE

a) Field of the Disclosure

The invention relates to an improved pico projection light system, and more particularly, to an optical engine of a pico projector having improved effects of lighting.

b) Brief Description of the Related Art

With miniaturization of a projector, a microminiature light source is required to be arranged for a pico projection lens and is adapted to be employed in an optical engine system of a pico projector. In order to meet market demand of miniaturization and lightweight for being easily carried around, an updated projector is improved to be equipped with light-emitting diodes (LED), acting as a light source, replacing a traditional light-receiving structure of a light cover.

The technology of a light-emitting diode, compared with that of a laser light encountering bottlenecks that it is difficult and cost-inefficient to gather red, blue and green laser lights due to the green laser light remaining to break through, is applied with relatively high performance. Accordingly, a light-emitting diode is now a mainstream trend for lighting of a pico projector. However, a light-emitting diode emits light with worse directivity and focus than a laser. Accordingly, the above disadvantages are necessarily improved by modulating a light system and by the way images projected on a screen have enhanced light uniformity.

In accordance with the invention, an improved projection light system employs collimators having three lenses each with a positive focal distance, and thereby light emitted by a light-emitting diode converges to a parallel light. A lens surface adjacent to the light-emitting diode is planar such that most diverged light can be converged within a limited distance.

In accordance with the invention, the improved projection light system employs the collimators having three lenses each with a positive focal distance, and thereby obtains enhanced light focus and relatively high efficiency.

In accordance with the invention, the improved projection light system employs a set of two lens arrays and two lenses each having a positive focal distance such that the converged parallel light can be converted into a uniform light projecting on a polarizing beam splitter (PBS) and a vertical polarized light reflects to a reflective liquid crystal panel, that is, a liquid crystal on silicon (LCoS).

In accordance with the invention, the improved projection light system employs a set of two lens arrays such that the incident parallel light can be divided into secondary lights in an array. Each of the secondary lights in the array can be magnified by rear lenses each having a positive focal distance and then can project on the reflective liquid crystal panel. Thereby, the secondary lights in the array overlap on the reflective liquid crystal panel and are complements to one another, and thus a uniform light can be obtained.

### SUMMARY OF THE DISCLOSURE

In accordance with the invention, an improved pico projection light system comprises a light-emitting diode, collimators, lens arrays, a positive lens, a polarizing beam splitter and a reflective liquid crystal panel arranged in sequence and with spaces therebetween, wherein the light-emitting diode is a light source.

In accordance with the invention, the improved pico projection light system comprises the light-emitting diode, the collimators, the lens arrays, the positive lens, the polarizing beam splitter and the reflective liquid crystal panel arranged in sequence and with spaces therebetween, wherein every three of the collimators with spaces therebetween are arranged as a set and used to convert light emitted by the light-emitting diode into a parallel light.

In accordance with the invention, the improved pico projection light system comprises the light-emitting diode, the collimators, the lens arrays, the positive lens, the polarizing beam splitter and the reflective liquid crystal panel arranged in sequence and with spaces therebetween, wherein every two of the lens arrays with at least a space therebetween are arranged as a set and used to uniformize the parallel light.

In accordance with the invention, the improved pico projection light system comprises the light-emitting diode, the collimators, the lens arrays, the positive lens, the polarizing beam splitter and the reflective liquid crystal panel arranged in sequence and with spaces therebetween, wherein light emitted from the lens arrays magnifies to a suitable power, next projects on the polarizing beam splitter and then reflects to the reflective liquid crystal panel.

In accordance with the invention, the improved pico projection light system comprises the light-emitting diode, the collimators, the lens arrays, the positive lens, the polarizing beam splitter and the reflective liquid crystal panel arranged in sequence and with spaces therebetween, wherein the polarizing beam splitter has a horizontal polarized light pass therethrough but has a vertical polarized light reflect to the reflective liquid crystal panel.

In accordance with the invention, the improved pico projection light system comprises the light-emitting diode, the collimators, the lens arrays, the positive lens, the polarizing beam splitter and the reflective liquid crystal panel arranged in sequence and with spaces therebetween, wherein the reflective liquid crystal panel reflects light and modulates optical signals projecting on a screen.

The accompanying drawings are included to provide a further understanding of the invention, and are incorporated as a part of this specification. The drawings illustrate embodiments of the invention and, together with the description, serve to explain the principles of the invention.

### BRIEF DESCRIPTION OF THE DRAWINGS

The drawings disclose illustrative embodiments of the present disclosure. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it refers to the same or like components or steps.

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure.

FIG. 1 is a schematic view of an improved pico projection light system in accordance with the invention.

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION OF THE INVENTION

Illustrative embodiments are now described. Other embodiments may be used in addition or instead. Details that may be apparent or unnecessary may be omitted to save space or for a more effective presentation. Conversely, some embodiments may be practiced without all of the details that are disclosed.

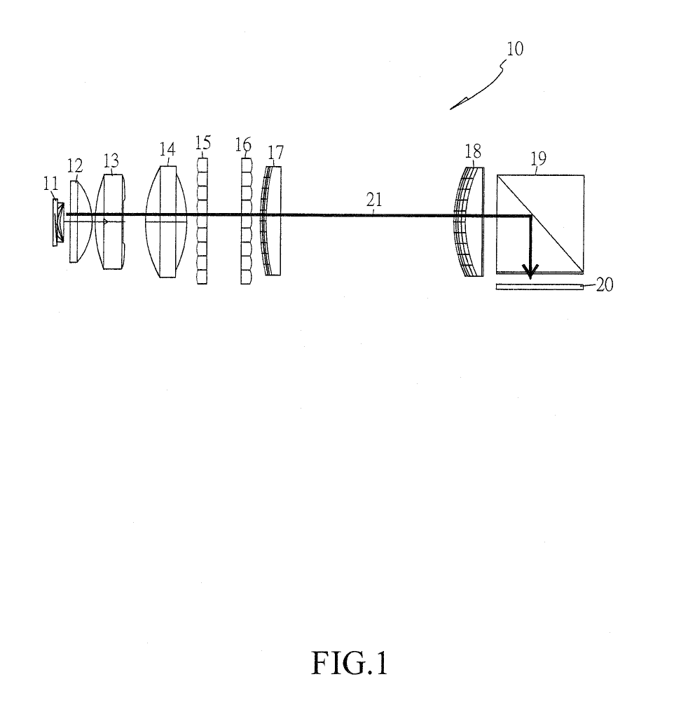

FIG. 1 is a schematic view of an improved pico projection light system in accordance with the invention. Referring to FIG. 1, a light system 10 of a pico projector comprises a light-emitting diode 11 (LED), collimators 12, 13 and 14, lens arrays 15 and 16, positive lenses 17 and 18, a polarizing beam splitter 19 and a reflective liquid crystal panel 20 arranged in sequence and with spaces therebetween, that is, arranged from front to back along a light focus path 21. The light-emitting diode 11 (11) is a light source of an optical engine. Every three of the collimators 12, 13 and 14 with spaces therebetween are arranged as a set and used to convert light emitted by the light-emitting diode 11 into a parallel light. Every two of the lens arrays 15 and 16 with at least a space therebetween are arranged as a set and used to uniformize the parallel light. The uniformization has a superior effect when each lens of the lens arrays 15 and 16 has a focal distance between 2 and 10 millimeters. Every two of the positive lens 17 and 18 with at least a space therebetween are arranged as a set such that light emitted from the lens arrays 15 and 16 magnifies to a suitable power, next projects on the polarizing beam splitter 19 and then reflects to the reflective liquid crystal panel 20, wherein the front one has a greater focal distance than that of the rear one. The polarizing beam splitter 19 (PBS) has a horizontal polarized light pass therethrough but has a vertical polarized light reflect to the reflective liquid crystal panel 20. The reflective liquid crystal panel 20, that is, a liquid crystal on silicon (LCoS), reflects light and modulates optical signals projecting on a screen.

In accordance with the invention, referring to FIG. 1, the light system 10 of the pico projector has a relatively small volume. The collimators 12, 13 and 14 are three lenses each with a positive focal distance, and thereby light emitted by the light-emitting diode 11 converges to a parallel light. The front collimator 12 has a planar surface facing the light-emitting diode 11 such that most diverged light can be converged within a limited distance.

In accordance with the invention, referring to FIG. 1, the light system 10 is provided with the lens arrays 15 and 16 and the lenses 17 and 18 each having a positive focal distance such that the converged parallel light can be converted into a uniform light projecting on the polarizing beam splitter 19 and a vertical polarized light reflects to the reflective liquid crystal panel 20. The lens arrays 15 and 16 are used to lead the incident parallel light to be divided into secondary lights in an array. Each of the secondary lights in the array can be magnified by the rear lenses 17 and 18 each having a positive focal distance and then can project on the reflective liquid crystal panel 20. Thereby, the secondary lights in the array overlap on the reflective liquid crystal panel 20 and are complements to one another, and thus a uniform light can be obtained.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Furthermore, unless stated otherwise, the numerical ranges provided are intended to be inclusive of the stated lower and upper values. Moreover, unless stated otherwise, all material selections and numerical values are representative of preferred embodiments and other ranges and/or materials may be used.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof.

What is claimed is:

1. A pico projection light system comprising:
a light-emitting diode acting as a light source;
a set of three collimators arranged with spaces therebetween and converting light emitted by the light-emitting diode into a parallel light;
a set of two lens arrays arranged with spaces therebetween and uniformizing the parallel light;
a set of two positive lenses arranged with spaces therebetween and magnifying light emitted from the lens arrays;
a polarizing beam splitter receiving the magnified light and having a horizontal polarized light pass therethrough; and
a reflective liquid crystal panel reflecting light and modulating optical signals projecting on a screen, wherein the light-emitting diode, the set of three collimators, the set of two lens arrays, the set of two positive lenses, the polarizing beam splitter and the reflective liquid crystal panel are arranged in sequence and with spaces therebetween, wherein the polarizing beam splitter has a vertical polarized light reflect to the reflective liquid crystal panel.

2. The pico projection light system of claim 1, wherein the set of three collimators comprises three lenses each having a positive focal distance and converging and collimating light emitted by the light-emitting diode, wherein the front one of the collimators has a planar surface facing the light-emitting diode.

3. The pico projection light system of claim 1, wherein the set of two positive lenses and the set of two lens arrays in front of the set of two positive lenses magnify the incident parallel light and have the incident parallel light uniformly project on the polarizing beam splitter.

4. The pico projection light system of claim 1, wherein each lens of the lens arrays has a focal distance between 2 and 10 millimeters.

5. The pico projection light system of claim 1, wherein the front one of the set of two positive lenses has a greater focal distance than the rear one of the set of two positive lenses.
